(19) United States
(12) Patent Application Publication
(10) Pub. No.: US 2026/0166466 A1
(43) Pub. Date: Jun. 18, 2026

(54) Smart Multistage VOCs Adsorption/Desorption Regeneration Apparatus and Control Method Thereof

(71) Applicant: EMSOLUTION CO., Ltd., Suwon (KR)

(72) Inventors: Hoon Min PARK, Yongin (KR); Hyun Min JUNG, Hwaseong (KR); Daehee LEE, Seoul (KR); Dal Hwan YOON, Jecheon (KR)

(21) Appl. No.: 19/332,399

(22) Filed: Sep. 18, 2025

(30) Foreign Application Priority Data
Dec. 18, 2024 (KR) 10-2024-0189836

(51) Int. Cl. B01D 53/04

(52) U.S. Cl. CPC B01D 53/0407; B01D 2259/40084; B01D 2259/41

(57) ABSTRACT

A smart multi-stage VOCs adsorption/desorption regeneration apparatus and its control method are disclosed. A smart multi-stage VOCs adsorption/desorption regeneration apparatus comprises: a contaminated gas inlet being provided at an upper end or a lower end of a housing into which contaminated gas is introduced; a contaminated gas outlet being provided at an end opposite to the contaminated gas inlet of the housing for discharging contaminated gas; a plurality of module insertion ports provided in a plurality of layers between the contaminated gas inlet and the contaminated gas outlet of the housing; and an adsorption/desorption module being inserted into each of the module insertion ports and sequentially adsorbing volatile organic compounds for each layer until contaminated gas being introduced from the contaminated gas inlet is discharged through the contaminated gas outlet.

### CROSS-REFERENCE TO RELATED APPLICATION

This present application claims priority to Korean Application No. 10-2024-0189836 filed on Dec. 18, 2024, the entire contents of which are hereby expressly incorporated by reference into the present application.

### TECHNICAL FIELD

The present invention relates to a smart multi-stage VOCs adsorption/desorption regeneration apparatus and a control method thereof. More specifically, the present invention provides a smart multi-stage VOCs adsorption/desorption regeneration apparatus and a control method that not only allows for the simple replacement of activated carbon without disassembling the adsorption tower but also enables the replacement of only the necessary amount of activated carbon by accurately determining the optimal replacement time.

### BACKGROUND ART

Activated carbon is widely used for exhaust gas purification, flue gas desulfurization, treatment of water and sewage, and the like.

Activated carbon is a collection of carbons with well-formed micropores, and is manufactured by carbonizing carbon-containing materials such as wood, sawdust, fruit seeds, coconut shells, coal, and lignite, and then activating them with hot air or steam.

Activated carbon has a surface area of micro pores that is usually 500 to 1700 m²/g, and the functional groups of carbon atoms on the surface exert an attractive force on the surrounding liquid or gas, thereby having the ability to adsorb molecules of the substance to be adsorbed.

These activated carbons are classified into powder activated carbon and granular activated carbon according to their shape, and although powder activated carbon and granular activated carbon are used differently depending on the processing form, their physical properties and adsorption mechanisms as activated carbon are similar.

Powder activated carbon is inexpensive, but its use is limited because the pressure drop is too large, and it is almost impossible to regenerate, whereas granular activated carbon has a sufficiently large surface area, has a small pressure drop, and can relatively easily recover the adsorbed substance, making it possible to regenerate, so it is the most widely used.

Exhaust gas generated from facilities such as incinerators, power plants, steel mills, food manufacturing plants, and painting facilities that produce odors, contains various pollutants and harmful substances, and adsorption towers using activated carbon are widely used to purify such exhaust gases.

Meanwhile, the adsorption efficiency of adsorption towers using general activated carbon decreases as the period of use increases, so the activated carbon needs to be replaced.

However, since the adsorption tower must be disassembled to replace the activated carbon, the work is not only quite cumbersome, but it is also difficult to accurately determine the appropriate replacement time for the activated carbon, so there is a problem of either replacing activated carbon that could still be used or replacing it only after the replacement timing has passed.

### DESCRIPTION OF THE INVENTION

### Technical Subject

The present invention was created to solve the above-mentioned problems, and the purpose of the present invention is to provide a smart multi-stage VOCs adsorption/desorption regeneration apparatus and a control method thereof, which can not only simply replace activated carbon without the need to disassemble an adsorption tower, but also accurately determine the replacement time of activated carbon and replace only the required amount of activated carbon.

### Technical Solution

According to an aspect of the present invention for achieving the above-described object, a smart multi-stage VOCs adsorption/desorption regeneration apparatus is characterized by comprising: a contaminated gas inlet being provided at an upper end or a lower end of a housing into which contaminated gas is introduced; a contaminated gas outlet being provided at an end opposite to the contaminated gas inlet of the housing for discharging contaminated gas; a plurality of module insertion ports provided in a plurality of layers between the contaminated gas inlet and the contaminated gas outlet of the housing; and an adsorption/desorption module being inserted into each of the module insertion ports and sequentially adsorbing volatile organic compounds for each layer until contaminated gas being introduced from the contaminated gas inlet is discharged through the contaminated gas outlet.

Herein, the adsorption/desorption module may include: a drawer-type frame in which upper surface and front surface thereof are covered, lower surface thereof is open, and a plurality of circular-type insertion holes thereof are formed in the upper surface; and a plurality of insertion modules being inserted into each of the insertion holes.

In addition, each of the insertion modules may include: an upper plate made of a disc with a diameter larger than that of the insertion hole, with a circular-type upper plate hole formed in the center of the disc; a lower plate formed with a diameter less than or equal to the diameter of the insertion hole; and an activated carbon member made in the shape of a cylinder being extended from a lower surface of the upper plate to an upper surface of the lower plate, and having a hole with the same diameter as a hole of the upper plate.

In addition, each of the insertion modules may further include a protective net with a mesh shape, having an outer circumferential surface being extended from a lower surface of the upper plate to an outer circumference of the lower plate, and an inner circumferential surface being extended from a circumference of the upper plate hole to an upper surface of the lower plate. In this case, it is preferable that the activated carbon member is formed of a plurality of activated carbon chunks having a size larger than a set size.

The aforementioned smart multi-stage VOCs adsorption/desorption regeneration apparatus may further include: a flow rate measuring unit that measures the flow rate per unit time of contaminated gas passing through the adsorption/desorption module of each layer; a flow rate ratio calculating unit that calculates the ratio of the flow rate of the previous layer measured by the flow rate measuring unit and the flow rate of the current layer; and an inspection signal transmitting unit that transmits an inspection signal to the adsorption/desorption module of the current layer when the ratio of the flow rate being calculated by the flow rate ratio calculating unit is less than or equal to a set value.

In addition, the aforementioned smart multi-stage VOCs adsorption/desorption regeneration apparatus may further include an inflow measurement unit that measures the inflow amount per unit time of contaminated gas being introduced through the contaminated gas inlet.

A control method of a smart multi-stage VOCs adsorption/desorption regeneration apparatus according to one aspect of the present invention for achieving the above-described object is characterized by including the steps of: measuring the outflow per unit time of contaminated gas passing through an adsorption/desorption module of each layer; calculating the output ratio of the measured previous layer to the outflow of the current layer; and transmitting an inspection signal to the adsorption/desorption module of the current layer when the ratio of the calculated outflow is less than or equal to a set value.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### Advantageous Effects

According to the present invention, not only can activated carbon be simply replaced without the need to disassemble the adsorption tower, but also the replacement time of activated carbon can be accurately determined and only the required amount of activated carbon can be replaced.

### BRIEF DESCRIPTION OF DRAWINGS

Preferred exemplary embodiments of the invention are illustrated in the accompanying drawings in which like reference numerals represent like parts throughout, and in which:

FIG. 1 is a schematic diagram illustrating a smart multi-stage VOCs adsorption/desorption regeneration apparatus according to an embodiment of the present invention.

FIG. 2 is a diagram illustrating an example of an adsorption/desorption module being inserted into a module insertion port of FIG. 1.

FIG. 3 is a diagram illustrating an example of an insertion module being inserted into an insertion hole of FIG. 2.

FIG. 4 is a diagram illustrating another example of an insertion module being inserted into an insertion hole of FIG. 2.

FIG. 5 is a diagram illustrating an example of multiple insertion modules being inserted into an adsorption/desorption module.

FIG. 6 is a diagram illustrating an example of VOCs adsorption using a smart multi-stage VOCs adsorption/desorption regeneration apparatus of FIG. 1.

FIG. 7 is a diagram illustrating another example of VOCs adsorption using a smart multi-stage VOCs adsorption/desorption regeneration apparatus of FIG. 1.

FIG. 8 is a diagram illustrating an example of a configuration added to a smart multi-stage VOCs adsorption/desorption regeneration apparatus of FIG. 1.

FIG. 9 is a flowchart illustrating a control method of a smart multi-stage VOCs adsorption/desorption regeneration apparatus according to an embodiment of the present invention.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DETAILED DESCRIPTION OF BEST MODE

Hereinafter, some embodiments of the present invention will be described with reference to exemplary drawings. When designating components in each drawing, identical components will be designated with the same reference numerals, wherever possible, even if they appear in different drawings. Furthermore, in describing embodiments of the present invention, detailed descriptions of related known structures or functions will be omitted if they are deemed to hinder understanding of the embodiments of the present invention.

In addition, in describing the components of the embodiment of the present invention, terms such as first, second, A, B, (a), and (b) may be used. These terms are merely intended to distinguish the components from other components, and the terms do not limit the nature, order or sequence of the components. When a component is described as being ‘connected’, ‘coupled’ or ‘interconnected’ to another component, the component may directly connected, coupled or interconnected to the other component, but it should be understood that another component may also be ‘connected’, ‘coupled’, or ‘interconnected’ between that component and that other components.

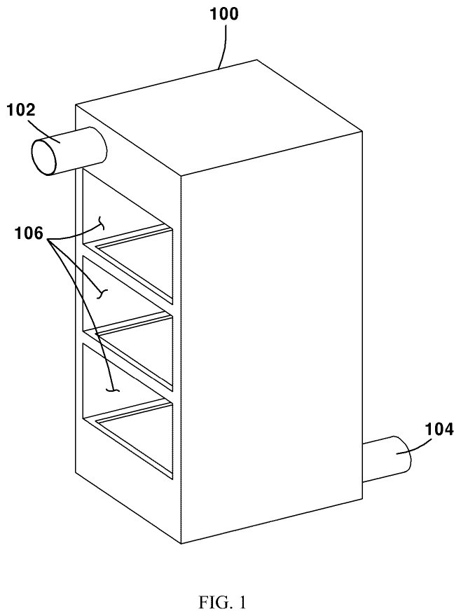

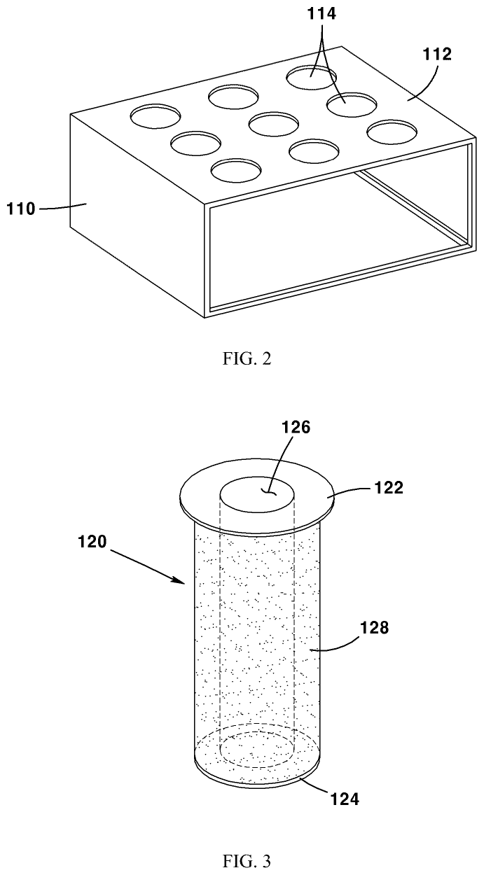

FIG. 1 is a schematic diagram illustrating a smart multi-stage VOCs adsorption/desorption regeneration apparatus according to an embodiment of the present invention; and FIG. 2 is a diagram illustrating an example of an adsorption/desorption module being inserted into a module insertion port of FIG. 1.

Referring to FIGS. 1 and 2, a smart multi-stage VOCs adsorption/desorption regeneration apparatus 100 according to an embodiment of the present invention includes a contaminated gas inlet 102, a contaminated gas outlet 104, a plurality of module insertion ports 106, and an adsorption/desorption module 110.

A contaminated gas inlet 102 is provided at the upper end or lower end of the housing, and contaminated gas is introduced therein. That is, the contaminated gas inlet 102 can introduce contaminated gas into an upper end of the housing or into a lower end of the housing. Here, the contaminated gas inlet 102 is provided at an upper end of the housing, and is illustrated and described as introducing contaminated gas into the upper end of the housing.

A contaminated gas outlet 104 is provided at an opposite end of a contaminated gas inlet 102 installed in a housing to discharge contaminated gas. That is, when the contaminated gas inlet 102 is provided at an upper end of the housing, the contaminated gas outlet 104 is provided at a lower end of the housing to discharge contaminated gas being introduced to an upper end through the contaminated gas inlet 102 from a lower portion of the housing to the outside. In addition, when the contaminated gas inlet 102 is provided at a lower end of the housing, the contaminated gas outlet 104 is provided at an upper end of the housing to discharge contaminated gas being introduced to a lower end through the contaminated gas inlet 102 from an upper end of the housing to the outside.

Here, each of the contaminated gas inlet 102 and the contaminated gas outlet 104 is provided with a corresponding fan (not shown), and the direction of the fan can be controlled to introduce contaminated gas into the interior of the housing or to discharge contaminated gas from the interior of the housing. In this case, it is preferable that the directions of the fans corresponding to the contaminated gas inlet 102 and the contaminated gas outlet 104 are controlled to be opposite to each other.

A plurality of module insertion ports 106 are provided in a plurality of layers between the contaminated gas inlet 102 and the contaminated gas outlet 104 of the housing. At this time, each module insertion port 106 may be formed as a square hole of the same size. In addition, each module insertion port 106 may be formed to form layers in the vertical direction. In FIG. 1, three module insertion ports 106 are illustrated as being formed in layers, but the number of module insertion ports 106 is not limited thereto and may be formed in various numbers. In addition, the interior of the housing corresponding to each module insertion port 106 is open to each other, and a support guide may be installed on an inner side wall of the housing to support an adsorption/desorption module 110 being inserted through the module insertion port 106.

The adsorption/desorption module 110 is provided in a number corresponding to the module insertion port 106 and is inserted into each module insertion port 106. At this time, the adsorption/desorption module 110 may have a hexahedral drawer-shaped frame in which an upper surface 112 and a front surface are covered, a lower surface is open, and a plurality of circular insertion holes 114 are formed in an upper surface 112, as illustrated in FIG. 2. In this case, the adsorption/desorption module 110 preferably has a front surface of the same size as the module insertion port 106, and the length from a front surface to a rear surface is preferably set to correspond to the length from a front surface to a rear surface of the housing. In addition, a lower end of a drawer-shaped frame of the adsorption/desorption module 110 is preferably supported by a support guide on an inner side of the housing when the adsorption/desorption module 110 is inserted into the module insertion port 106.

Here, the adsorption/desorption module 110 inserted into each module insertion port 106 forms a layer between the contaminated gas inlet 102 and the contaminated gas outlet 104, and can sequentially adsorb volatile organic compounds in each layer until the contaminated gas being introduced from the contaminated gas inlet 102 is discharged through the contaminated gas outlet 104.

FIG. 3 is a drawing showing an example of an insertion module inserted into the insertion hole of FIG. 2. Here, the insertion module 120 is formed in a cylindrical shape and is inserted into each insertion hole 114 formed on the upper surface 112 of the adsorption/desorption module 110. At this time, the insertion module 120 may include an upper plate 122, a lower plate 124, and an activated carbon member 128, as illustrated in FIG. 3.

The upper plate 122 is formed of a disc with a diameter larger than the diameter of the insertion hole 114 formed on an upper surface 112 of the adsorption/desorption module 110, and a circular upper plate hole 126 is formed in the center thereof.

The lower plate 124 is formed with a diameter smaller than the diameter of the insertion hole 114 formed in an upper surface 112 of the adsorption/desorption module 110. At this time, it is preferable that the diameter of the lower plate 124 be formed with a diameter larger than the diameter of the upper plate hole 126 formed in the upper plate 122.

The activated carbon member 128 is manufactured using activated carbon and may be formed in a cylindrical shape being extended from a lower surface of the upper plate 122 to an upper surface of the lower plate 124. At this time, the activated carbon member 128 has activated carbon holes having the same diameter as the upper plate holes 126 of the upper plate 122, and preferably extended from a lower surface of the upper plate 122 to an upper surface of the lower plate 124 such that the central axis of the activated carbon holes coincides with the central axis of the upper plate holes 126. In addition, the length of the activated carbon member 128 is preferably formed to be less than or equal to the height of the adsorption/desorption module 110.

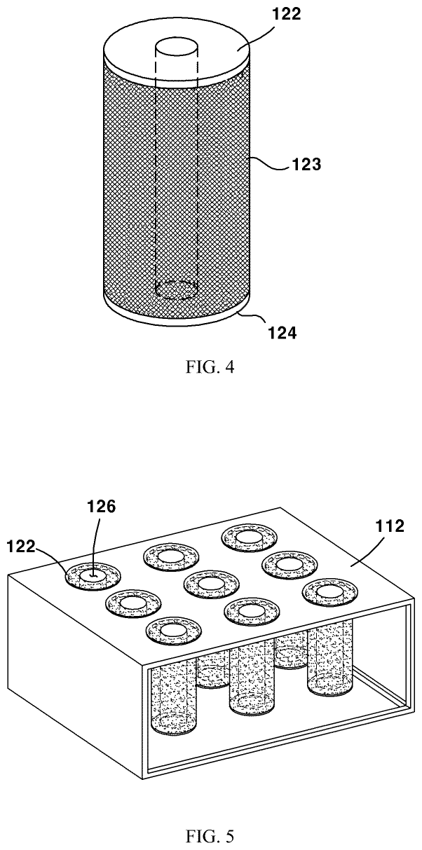

Meanwhile, the insertion module 120 may further include a protective net 123, as illustrated in FIG. 4. At this time, the protective net 123 has an outer circumferential surface being extended from a lower surface of the upper plate 122 to an outer circumferential surface of the lower plate 124, and an inner circumferential surface being extended from a circumference of the upper plate hole 126 of the upper plate 122 to an upper surface of the lower plate 124, and may be implemented in the shape of a mesh. In this case, the activated carbon member 128 is formed of a plurality of activated carbon chunks set to a size larger than each hole of the mesh, and may be filled between an outer circumferential surface of the protective net 123 and an inner circumferential surface.

As illustrated in FIG. 5, the insertion module 120 is inserted into the adsorption/desorption module 110 through each insertion hole 114 formed on an upper surface of the adsorption/desorption module 110. At this time, since the diameter of the upper plate 122 of the insertion module 120 is larger than the diameter of the insertion hole 114, the insertion module 120 is suspended from the upper surface 112 of the adsorption/desorption module 110.

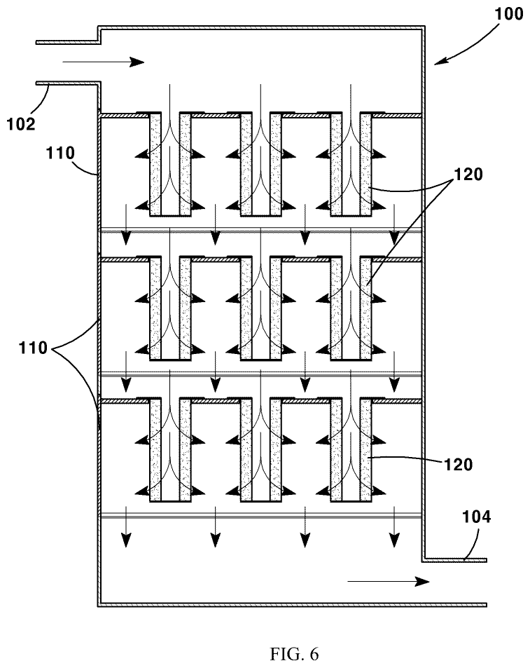

FIG. 6 is a diagram illustrating an example of VOCs adsorption using a smart multi-stage VOCs adsorption/desorption regeneration apparatus of FIG. 1.

Referring to FIG. 6, a smart multi-stage VOCs adsorption/desorption regeneration apparatus 100 according to an embodiment of the present invention introduces contaminated gas into an upper end of the housing and discharges the contaminated gas from a lower end of the housing.

Here, the contaminated gas being introduced into the upper end of the housing is sucked through the activated carbon holes of the insertion module 120 inserted into the adsorption/desorption module 110 because the upper surface 112 of the adsorption/desorption module 110 is covered and the lower surface of the insertion module 120 is blocked by the lower plate 124 and is discharged laterally of the insertion module 120. At this time, VOCs (Volatile Organic Compounds) included in the contaminated gas are adsorbed by the activated carbon and loaded on the inside of the activated carbon holes.

At this time, since each adsorption/desorption module 110 is inserted into the module insertion port 106 in multiple layers, the contaminated gas being introduced to an upper end of the housing is sequentially adsorbed by the adsorption/desorption module 110 of each layer, and finally, the filtered clean gas is discharged through the contaminated gas outlet 104.

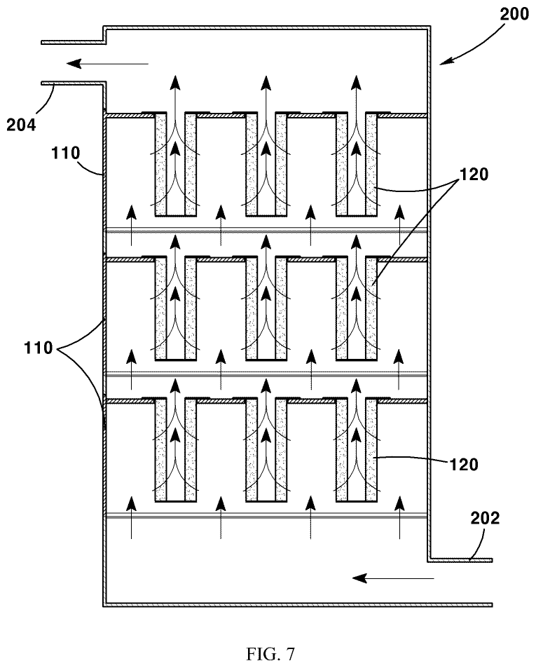

FIG. 7 is a diagram illustrating another example of VOCs adsorption using a smart multi-stage VOCs adsorption/desorption regeneration apparatus of FIG. 1.

Referring to FIG. 7, a smart multi-stage VOCs adsorption/desorption regeneration apparatus 200 according to an embodiment of the present invention introduces contaminated gas into a lower end of the housing and discharges contaminated gas from an upper end of the housing.

Here, the contaminated gas being introduced into a lower end of the housing is sucked in laterally toward the insertion module 120 and discharged upward through the activated carbon holes of the insertion module 120 because the upper surface 112 of the adsorption/desorption module 110 is covered and the lower surface of the insertion module 120 is blocked by the lower plate 124. At this time, the VOCs included in the contaminated gas are loaded on the outside of the insertion module 120.

At this time, since each adsorption/desorption module 110 is inserted into the module insertion port 106 in multiple layers, the contaminated gas being introduced to a lower end of the housing is sequentially adsorbed by the adsorption/desorption module 110 of each layer, and finally, the filtered clean gas is discharged through the contaminated gas outlet 102.

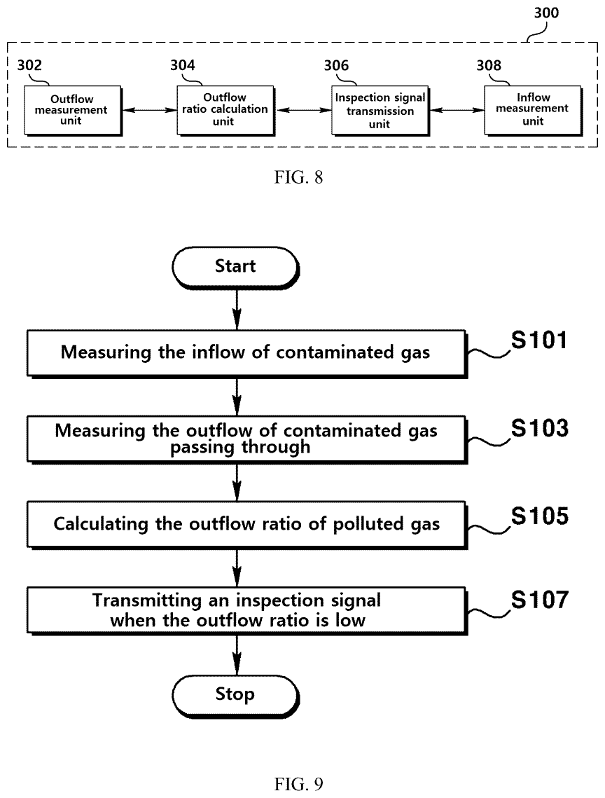

FIG. 8 is a diagram illustrating an example of a configuration added to a smart multi-stage VOCs adsorption/desorption regeneration apparatus of FIG. 1.

Referring to FIG. 8, a smart multi-stage VOCs adsorption/desorption regeneration apparatus 300 according to an embodiment of the present invention may further include an outflow measurement unit 302, an outflow ratio calculation unit 304, an inspection signal transmission unit 306, and an inflow measurement unit 308 with respect to the smart multi-stage VOCs adsorption/desorption regeneration apparatus 100 shown in FIG. 1.

The outflow measurement unit 302 measures the outflow per unit time of the contaminated gas passing through the adsorption/desorption module 110 of each layer. That is, the outflow measurement unit 302 is installed on each layer corresponding to each adsorption/desorption module 110 forming the layer, and measures the outflow per unit time of the contaminated gas passing through the adsorption/desorption module 110 of the previous layer. At this time, as the amount of volatile organic compounds being adsorbed by the adsorption/desorption module 110 increases, the amount of contaminated gas passing through the adsorption/desorption module 110 decreases, and accordingly, the outflow per unit time measured by the outflow measurement unit 302 decreases.

The outflow rate calculation unit 304 calculates the output ratio of the previous layer measured by the outflow measurement unit 302 and the outflow of the current layer. That is, the outflow rate calculation unit 304 compares the outflow per unit time of the contaminated gas passing through the adsorption/desorption module 110 of the previous layer in the current layer with the outflow per unit time of the contaminated gas passing through the adsorption/desorption module 110 of the previous layer in the previous layer.

The inspection signal transmitting unit 306 transmits an inspection signal to the adsorption/desorption module 110 of the current layer when the outflow ratio calculated by the outflow ratio calculating unit 304 is less than or equal to a set value.

The inflow measurement unit 308 measures the inflow per unit time of the contaminated gas being introduced through the contaminated gas inlet 102. That is, the inflow measurement unit 308 measures the inflow per unit time of the contaminated gas being introduced into an upper end or a lower end of the housing.

At this time, since each adsorption/desorption module 110 is installed in layers, the outflow per unit time of the contaminated gas of each adsorption/desorption module 110 generally decreases similarly at a rate within a set range until the contaminated gas is introduced through the contaminated gas inlet 102 and is discharged through the contaminated gas outlet 104. Accordingly, when the outflow of the contaminated gas corresponding to each adsorption/desorption module 110 is lower than the set rate with respect to the inflow per unit time of the contaminated gas measured by the inflow measurement unit 308, the inspection signal transmission unit 306 can transmit an inspection signal for each adsorption/desorption module 110.

In addition, when the output ratio of the contaminated gas corresponding to the adsorption/desorption module 110 of a specific layer falls below a set range compared to the outflow of the contaminated gas corresponding to the adsorption/desorption module 110 of another layer, the inspection signal transmitting unit 306 may transmit an inspection signal for the adsorption/desorption module 110 corresponding to the specific layer.

Through this, the smart multi-stage VOCs adsorption/desorption regeneration apparatus 300 according to an embodiment of the present invention can not only accurately determine the replacement or inspection time for the adsorption/desorption module 110 of each layer, but also accurately determine whether to replace or inspect the adsorption/desorption module 110 of a specific layer, and can also perform replacement of activated carbon for the necessary part.

FIG. 9 is a flowchart illustrating a control method of a smart multi-stage VOCs adsorption/desorption regeneration apparatus according to an embodiment of the present invention. The control method of the smart multi-stage VOCs adsorption/desorption regeneration apparatus according to an embodiment of the present invention can be performed by the smart multi-stage VOCs adsorption/desorption regeneration apparatus 300 shown in FIG. 8.

Referring to FIGS. 1 to 9, the smart multi-stage VOCs adsorption/desorption regeneration apparatus 300 measures the inflow per unit time of the contaminated gas being introduced through the contaminated gas inlet 102 (S101). In other words, the smart multi-stage VOCs adsorption/desorption regeneration apparatus 300 measures the inflow per unit time of the contaminated gas being introduced into an upper end or a lower end of the housing.

The smart multi-stage VOCs adsorption/desorption regeneration apparatus 300 measures the outflow per unit time of the contaminated gas passing through the adsorption/desorption module 110 of each layer (S103). In other words, the smart multi-stage VOCs adsorption/desorption regeneration apparatus 300 measures the outflow per unit time of the contaminated gas passing through the adsorption/desorption module 110 of the previous layer corresponding to each adsorption/desorption module 110 forming the layer. At this time, as the amount of volatile organic compounds being adsorbed by the adsorption/desorption module 110 increases, the amount of contaminated gas passing through the adsorption/desorption module 110 decreases, and accordingly, the measured outflow per unit time decreases.

The smart multi-stage VOCs adsorption/desorption regeneration apparatus 300 calculates the output ratio of the previous layer and the outflow of the current layer (S105). In other words, the smart multi-stage VOCs adsorption/desorption regeneration apparatus 300 compares the contaminated gas outflow per unit time from the current layer, which passed through the adsorption/desorption module 110 of the previous layer, with the contaminated gas outflow per unit time from the previous layer, which passed through the adsorption/desorption module 110 of the layer before it.

The smart multi-stage VOCs adsorption/desorption regeneration apparatus 300 transmits an inspection signal to the adsorption/desorption module 110 of the current layer when the ratio of the produced outflow is below a set value (S107).

At this time, since each adsorption/desorption module 110 is installed in layers, the outflow per unit time of the contaminated gas of each adsorption/desorption module 110 decreases similarly at a rate within a generally set range until the contaminated gas is introduced through the contaminated gas inlet 102 and is discharged through the contaminated gas outlet 104. Accordingly, when the outflow of the contaminated gas corresponding to each adsorption/desorption module 110 is lower than the set rate with respect to the inflow per unit time of the measured contaminated gas, the smart multi-stage VOCs adsorption/desorption regeneration apparatus 300 can transmit an inspection signal to each adsorption/desorption module 110.

In addition, when the output ratio of contaminated gas corresponding to the adsorption/desorption module 110 of a specific layer compared to the outflow of contaminated gas corresponding to the adsorption/desorption module 110 of another layer falls below a set range, the smart multi-stage VOCs adsorption/desorption regeneration apparatus 300 may transmit an inspection signal to the adsorption/desorption module 110 corresponding to the specific layer.

Through this, the smart multi-stage VOCs adsorption/desorption regeneration apparatus 300 according to an embodiment of the present invention can not only accurately determine the replacement or inspection time for the adsorption/desorption module 110 of each layer, but also accurately determine whether to replace or inspect the adsorption/desorption module 110 of a specific layer, and can also perform replacement of activated carbon for the necessary parts.

Although embodiments according to the present invention have been described above, these are merely exemplary. Those with ordinary skill in the art will understand that various modifications and embodiments within an equivalent range are possible. Therefore, the scope of protection of the present invention should be defined not only by the following claims but also by their equivalents.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

Moreover, the individual components need not be formed in the disclosed shapes, or assembled in the disclosed configuration, but could be provided in virtually any shape, and assembled in virtually any configuration. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

We claim:

1. A smart multistage VOCs adsorption & desorption regeneration system comprising:
a contaminated gas inlet being provided at an upper end or a lower end of the housing for the inflow of contaminated gas;
a contaminated gas outlet being provided at an opposite end of the housing from the contaminated gas inlet for discharging the contaminated gas; and
a plurality of module insertion ports arranged in multiple layers between the contaminated gas inlet and the contaminated gas outlet within the housing; and
an adsorption/desorption module being inserted into each of the module insertion ports, which sequentially adsorbs volatile organic compounds layer by layer as the contaminated gas is introduced from the contaminated gas inlet until it is discharged through the contaminated gas outlet.

2. The smart multistage VOCs adsorption & desorption regeneration system of claim 1, further comprising:
a drawer-type frame in which upper surface and front surface thereof are covered, lower surface thereof is open, and a plurality of circular-type insertion holes thereof are formed in the upper surface; and
a plurality of insertion modules being inserted into each of the insertion holes.

3. The smart multistage VOCs adsorption & desorption regeneration system of claim 2, wherein each of the insertion modules further comprises:
an upper plate made of a disc with a diameter larger than that of the insertion hole, with a circular-type upper plate hole formed in the center of the disc;
a lower plate formed with a diameter less than or equal to the diameter of the insertion hole; and
an activated carbon member made in the shape of a cylinder being extended from a lower surface of the upper plate to an upper surface of the lower plate, and having a hole with the same diameter as a hole of the upper plate.

4. The smart multistage VOCs adsorption & desorption regeneration system of claim 3, wherein each of the insertion modules further comprises:
a protective net with a mesh shape, having an outer circumferential surface being extended from a lower surface of the upper plate to an outer circumference of the lower plate, and an inner circumferential surface being extended from a circumference of the upper plate hole to an upper surface of the lower plate,
wherein the activated carbon member is formed of a plurality of activated carbon chunks having a size larger than a set size.

5. The smart multistage VOCs adsorption & desorption regeneration system of claim 1, further comprising:
an outflow measurement unit for measuring the outflow per unit time of contaminated gas passing through the adsorption/desorption module of each layer;
an outflow ratio calculation unit for calculating the output ratio of the previous layer measured by the outflow measurement unit to the outflow of the current layer; and
an inspection signal transmission unit for transmitting an inspection signal to the adsorption/desorption module of the current layer when the output ratio calculated by the outflow ratio calculation unit is less than a set value.

6. The smart multistage VOCs adsorption & desorption regeneration system of claim 5, further comprising:
an inflow measurement unit that measures the inflow amount per unit time of contaminated gas being introduced through the contaminated gas inlet.

7. A method for controlling smart multi-stage VOCs adsorption/desorption regeneration apparatus of claim 1, comprising the steps of:
measuring the outflow per unit time of contaminated gas passing through the adsorption/desorption module of each layer;
calculating the output ratio of the previous layer to the outflow of the current layer; and
transmitting an inspection signal to the adsorption/desorption module of the current layer when the output ratio is less than a set value.
